(19) United States
(12) Patent Application Publication
(10) Pub. No.: US 2012/0151543 A1
(43) Pub. Date: Jun. 14, 2012

(54) IPTV INTERACTIVE SYSTEM AND DEVICE AND INTERACTIVE METHOD THEREOF

(76) Inventors: Chih-Chun LAI, Taipei City (TW); Yao-Min Huang, Taipei City (TW); Han-Fen Lee, Taipei City (TW)

(21) Appl. No.: 12/976,655

(22) Filed: Dec. 22, 2010

(30) Foreign Application Priority Data
Dec. 9, 2010 (TW) 099143017

(51) Int. Cl. H04N 7/173

(52) U.S. Cl. 725/110

(57) ABSTRACT

An IPTV interactive system and device and an interactive method thereof are provided. The system includes a user side and a server side. The user side has a digital signal control device and includes: a user side time calibration unit; a display unit, used for playing multimedia information; an operation unit, used for outputting a control signal; and a signal receiving unit, used for receiving the control signal. The server side includes: a server side time calibration unit, used for adjusting a time of the user side to be synchronous with the server side; an application server, used for generating and displaying a widget menu page including multiple operation options; a network server, used for transferring an option of the widget menu page corresponding to the control signal to the user side; and a database, used for storing at least a piece of correlation information corresponding to the multimedia information.

### CROSS-REFERENCE TO RELATED APPLICATION

This application claims the benefit of Taiwan Patent Application No. 099143017, filed on Dec. 9, 2010, which is hereby incorporated by reference for all purposes as if fully set forth herein.

### BACKGROUND OF THE INVENTION

1. Field of Invention

The present invention relates to an Internet Protocol television (IPTV) interactive system and device and an interactive method thereof, and more particularly to an IPTV interactive system and device and an interactive method thereof capable of providing a widget menu page corresponding to multimedia information according to contents of television programs.

2. Related Art

With the increase of network speed, more and more multimedia data such as music or movies can be viewed and downloaded on a network. However, the downloaded movies usually can only be viewed on a computer and it is slightly difficult for multiple persons to watch at the same time. Although some manufacturers already launched products capable of directly reading computer medium files and be connected to television to play movies, the time and energy spent to get familiar with products leads to an additional burden for users.

Currently, IPTV services launched by telecommunication companies all emphasize differences thereof from a conventional television, for example, a Video on Demand (VOD) function enables a television user to flexibly choose the time of watching moves or television program. The program interactive function enables users to join in activities such as bets, scratch cards, and interesting quizzes through televisions. The related services bring brand new experiences to television watching of users. However, when the user wants to watch movie files in his own computer and enjoy the fun of media sharing, it's a pity that the IPTV does not provide related services. Thus, the conventional mode still has many deficiencies, which is practically not a great design and urgently needs improvement.

### SUMMARY OF THE INVENTION

The present invention provides an IPTV interactive system and device and an interactive method thereof, in which mainly a digital signal control device at a user side performs interaction with services provided by a server side, so as to increase convenience of acquiring related information of television programs by a user through the IPTV interactive system and device and the interactive method thereof.

The present invention provides an IPTV interactive system, which mainly comprises a user side and a server side. The user side is disposed with a digital signal control device and comprises a user side time calibration unit, a display unit, an operation unit, and a signal receiving unit. The user side time calibration unit is disposed at the digital signal control device. The display unit is used for displaying multimedia information. The operation unit outputs a control signal to the signal receiving unit. The signal receiving unit is disposed at the digital signal control device to receive the control signal.

The server side comprises a server side time calibration unit, an application server, a network server, and a database. The server side time calibration unit is linked to the user side time calibration unit to adjust a time of the user side to be synchronous with the server side. The application server generates a widget menu page corresponding to multimedia information through different parameters, and displays the widget menu page at the display unit of the user side. The widget menu page comprises at least a widget.

The network server transfers information of a widget of a widget menu page corresponding to the control signal to the user side and displays the information at the display unit according to the control signal of the user side, and the database stores at least a piece of correlation information corresponding to multimedia information, so as to provide the correlation information for access by the application server and the network server, and the correlation information is saved according to the control signal.

The user side operates the digital signal control device through the operation unit via the display unit, the digital signal control device is linked to the network server and the application server of the server side through an Internet, so as to access related data in the database, the digital signal control device transfers correlation information provided by the network server through the Internet back to the user side for view through the display unit, and executes other function applications through the operation unit.

The present invention provides an IPTV interactive device, which mainly includes a user side and a server side. The user side comprises a digital signal control device, an operation unit, a display unit, a user side time calibration unit, and a signal receiving unit.

The user side time calibration unit is disposed at the digital signal control device. The display unit is electrically connected to the digital signal control device to display multimedia information. The operation unit outputs a control signal to the signal receiving unit disposed at the digital signal control device.

The server side comprises a server side time calibration unit, an application server, a network server, and a database. The server side time calibration unit is linked to the user side time calibration unit to adjust a time of the user side to be synchronous with the server side. The application server generates a widget menu page corresponding to the multimedia information through different parameters, and displays the widget menu page at the display unit of the user side. The widget menu page comprises at least a widget. The network server transfers information of the widget corresponding to the control signal to the user side and displays the information at the display unit according to the control signal of the user side. The database stores at least a piece of correlation information corresponding to the multimedia information, so as to provide the correlation information for access by the application server and the network server, and saves the correlation information according to the control signal.

The user side operates the digital signal control device through the operation unit via the display unit, the digital signal control device is linked to the network server and the application server of the server side through an Internet, so as to access related data in the database, and the digital signal control device transfers correlation information provided by the network server through the Internet back to the user side to be viewed through the display unit, and the operation unit executes other function applications.

The present invention further provides an IPTV interactive method, which comprises the following steps. First, a server side time calibration unit at a server side and a user side time calibration unit are connected through an Internet to calibrate a time of a digital signal control device. Next, an application server of the server side generates a widget menu page corresponding to multimedia information through different parameters, and displays the widget menu page at the display unit of the user side. An operation unit inputs a control signal in the signal receiving unit and a network server of the server side is enabled according to the control signal to provide information of a widget corresponding to the control signal to be transferred to the user side and displayed at the display unit. Finally, the correlation information corresponding to the control signal is stored in the database.

In an embodiment of the present invention, the digital signal control device provides television program content as well as web browsing content, program content information, and program music play content related thereto to the user side.

In an embodiment of the present invention, the each widget is set with an identification code, and the application server recognizes an operation function set for the widget through the identification code.

In an embodiment of the present invention, the widget menu page is arranged in classes and groups, so as to enable the user side to clearly find target content. The database further establishes an index catalog according to the television programs.

In an embodiment of the present invention, the application server receives a web browsing HyperText Transfer Protocol (HTTP) request sent by the digital signal control device from the Internet, and returns an HTTP response to the digital signal control device, and at the same time a web page acquires information required thereby from the database, and transfers web page content through Internet to the digital signal control device for display at the display unit of the user side.

In an embodiment of the present invention, the digital signal control device further comprises a bookmark function, the bookmark function records a list of widgets related to the watching program, for future representation, and the function application comprises two operation modes of adding a bookmark and loading a book mark.

In an embodiment of the present invention, the application server further comprises a real-time interactive function, and the real-time interactive function provides interactive games for a voting or questionaire survey function.

In an embodiment of the present invention, the server side time calibration unit is connected to a television station through the Internet to calibrate a time of the server side, and then the user side time calibration unit is accordingly connected to calibrate the time of the user side, so the user side, the server side, and a time of the television station are synchronous with each other. The server side time calibration unit adopts information of a System Time Table (SST) in Program and System Information Protocol (PSIP) data to calibrate the calibration unit of the user side time to calibrate the time of the user side to be synchronous with the server side.

The present invention adopts the structure of interaction between the user side and the server side, so the server side makes a widget menu page corresponding to television program content according to content presented by each television program, such that the user can execute links of related information or further learn related messages of various information through the widget menu page.

### BRIEF DESCRIPTION OF THE DRAWINGS

The present invention will become more fully understood from the detailed description given herein below for illustration only, and thus are not limitative of the present invention, and wherein:

FIG. 1 is a schematic block diagram of an IPTV interactive system according to the present invention;

FIG. 2 is a schematic view of an IPTV interactive device according to the present invention;

FIG. 3 is a flow chart of steps of an IPTV interactive method according to the present invention;

FIG. 4 is a flow chart of steps of establishing a bookmark function of an IPTV interactive method according to the present invention; and

FIG. 5 is a flow chart of steps that a database establishes an index according to television programs of an IPTV interactive method according to the present invention.

### DETAILED DESCRIPTION OF THE INVENTION

In order to make the features and advantages of the present invention more comprehensible, the embodiments are illustrated below in detail with reference to the accompanying drawings.

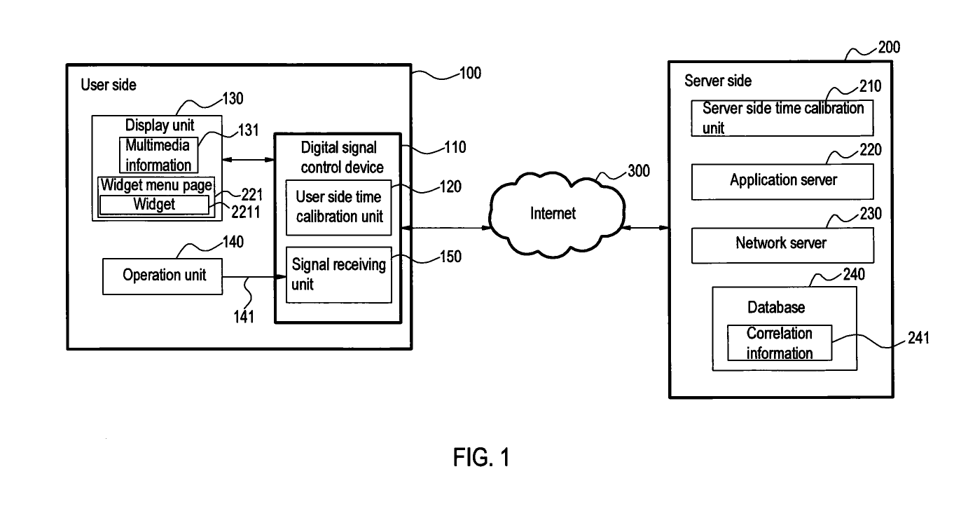

FIG. 1 is a schematic block diagram of an IPTV interactive system according to the present invention. In FIG. 1, mainly an IPTV interactive system is depicted, and the system mainly includes a user side 100 and a server side 200. The user side 100 is disposed with a digital signal control device 110 and includes a user side time calibration unit 120, a display unit 130, an operation unit 140, and a signal receiving unit 150. The user side time calibration unit 120 is disposed at the digital signal control device 110. The display unit 130 displays multimedia information 131. The operation unit 140 outputs a control signal 141 to the signal receiving unit 150.

The server side 200 includes a server side time calibration unit 210, an application server 220, a network server 230, and a database 240. The server side time calibration unit 210 is linked to the user side time calibration unit 120 to adjust a time of the user side 100 to be synchronous with the server side 200. Furthermore, the server side time calibration unit 210 is connected to a television station through the Internet 300 to calibrate a time of the server side 200, and ten the user side time calibration unit 120 is accordingly connected to calibrate the time of the user side 100, so the user side 100, the server side 200, and the television station time are synchronous.

The application server 220 generates a widget menu page 221 corresponding to the multimedia information 131 through different parameters and displays the widget menu page 221 at the display unit 130 of the user side 100. The widget menu page 221 includes at least a widget 2211. The network server 230 transfers information of the widget 2211 corresponding to the control signal 141 to the user side 100 and displays the information at the display unit 130 according to the control signal 141 of the user side 100. The database 240 stores at least a piece of correlation information 241 corresponding to the multimedia information 131, so as to provided the correlation information 241 for access by the application server 220 and the network server 230, and saves the correlation information 241 according to the control signal 141.

The user side 100 operates the digital signal control device 110 through the operation unit 140 via the display unit 130, the digital signal control device 110 is linked to the network server 230 and the application server 220 of the server side 200 through an Internet 300, so as to access the correlation information 241 at the database 240, the digital signal control device 110 is enabled through the Internet 300 to transfer the correlation information 241 provided by the network server 230 through the database 240 back to the user side 100 for being viewed through the display unit 130, and the operation unit 140 executes other function applications.

In this embodiment, the digital signal control device provides television program content as well as web browsing content, program content information, and program music play content related thereto to the user side.

In this embodiment, each widget is set with an identification code, and the application server recognizes an operation function set by the widget through the identification code.

In this embodiment, the widget menu page is arranged in classes and groups, so as to enable the user side to clearly find target content. The database further establishes an index catalog according to the television programs.

In this embodiment, the application server receives a web browsing HTTP request sent by the digital signal control device from the Internet, and returns an HTTP response to the digital signal control device, and at the same time the web page acquires information required thereby from the database, and transfers the web page content through the Internet to the digital signal control device for display at the display unit of the user side.

In this embodiment, the digital signal control device further includes a bookmark function, the bookmark function records a list of widgets related to the watching program, for future representation, and the function application includes two operation modes of adding a bookmark and loading a bookmark.

In this embodiment, the application server further includes a real-time interactive function, and the real-time interactive function provides interactive games for a voting or questionaire survey function.

In this embodiment, the server side time calibration unit adopts information of SST in the PSIP data to calibrate the time calibration unit of the user side to calibrate the time of the user side to be synchronous with the server side.

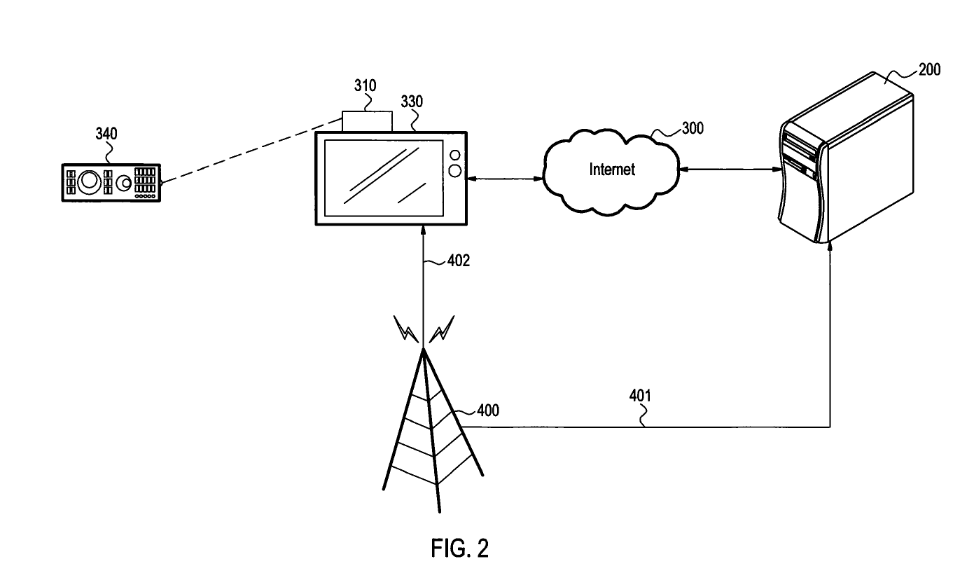

Referring to FIG. 1 at the same time, FIG. 2 is a schematic view of an IPTV interactive device according to the present invention. In this embodiment, an implementation status that the present invention is applied in a common television is depicted. Generally speaking, a television 330 mainly receives television wave signals 402 transferred by a television station 400, and the television wave signals 402 are transcoded and played on the television 330. The television station 400 provides a television program guide 401 to the server side 200 in advance. The digital signal control device 310 is linked to the server side 200 through the Internet 300. Furthermore, in this embodiment, as a common television is unable to play the television program and overlap signals input from outside on the program for display at the same time, the digital signal control device 310 receives the television wave signals 402 of the television station 400, transcodes the television wave signals 402, combines the television wave signals 402 and interactive contents, and then outputs the combined result to the television 300 for display. In addition, in this embodiment, the digital signal control device 310 can also be directly integrated inside the television 330.

The server side time calibration unit 210 of the server side 200 adjusts a time of the digital signal control device 310 to be synchronous with the server side 200, and displays the widget menu page generated by the application server 220 on a screen of the television 330. At this time, a remote controller 340 emits a control signal, and transfers an option of the widget menu page corresponding to the control signal to the television 330 through the network server 230 of the server side 200 by using a streaming technology and plays the option through the television 330, and at least a piece of correlation information 241 corresponding to the multimedia information is stored in the database 240 of the server side 200, so as to provide the correlation information for access by the application server 220 and the network server 230, and saves correlation information 241 according to the control signal.

In this embodiment, a field of the widget menu page generated by the application server 220 at least includes the following information:

(1) Identification Code: a widget of each widget menu page has a unique corresponding identification code.

(2) Channel: used for establishing correlation with a channel (a plurality of channels is able to be used)

(3) Keyword: used for establishing correlation of programs by using program names, types, and guests.

(4) Start Time: a time that a widget menu page becomes valid; fill 0 if real-time validity is required.

(5) End Time: a time that a widget menu page becomes invalid; fill 0 if no limit exists.

(6) Update Time: used for examining a version of a widget menu page.

Furthermore, when a user side signs in, the user can query from the server side 200 in terms of the channel being watched, the server side 200 transfers back a widget menu page related to a current program according to the channel transferred by the user side and at the same time also transfers back preparation of a widget menu page related to a next program.

After acquiring a widget menu page list, the user side has to first perform time synchronization with the server side 200 to guarantee preparation of time while the server side 200 has to provide NTP services with a time synchronization server side 200 of the television station 400, so the digital signal control device 310 calibrates time, and if the valid time of the widget menu page already starts, a message of a widget menu page is displayed in the picture of the television 330.

If the program is half finished, the application server 220 has new parameters relative to the program, and a message of a new real-time widget menu page is displayed in a screen picture of the television 330.

After seeing a prompt in the picture, the user can press the remote controller 340 to display the widget menu page related to the program, and clicks updated function options to request download from the server side 200 with the identification code.

The widget menu page further includes:

(1) A time-sensitive widget is directly downloaded and executed after being clicked, automatically deleted when a time limit is reached, and only deleted after being turned off by a user if the widget is still being executed when the time limit is reached.

(2) A time-insensitive widget has to be used after installation; after being clicked in a list, it is queried whether to perform installation; and the widget is installed and executed after confirmation, and otherwise, the widget is not executed. Such widgets appear in the installation list of the widget menu page after being installed, and the user can call the list by pressing a remote controller 340 and access during non-programming time.

In addition, the digital signal control device confirms a connection state of the server side every other preset period. If the connection times out or does not exist, the connection is reestablished automatically.

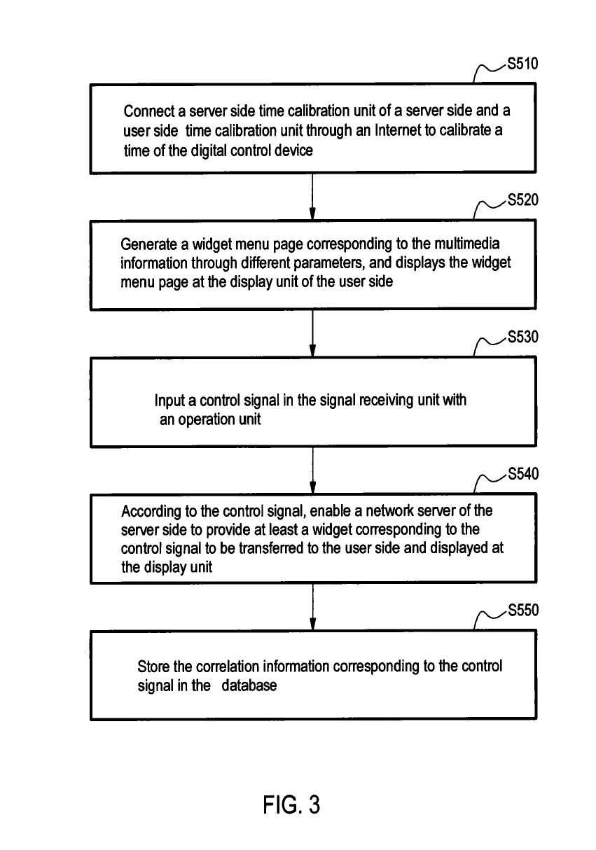

FIG. 3 is a flow chart of steps of an IPTV interactive method according to the present invention. In this embodiment, the IPTV interactive method is applied to a user side disposed with a digital signal control device and a server side. The user side includes at least a user side time calibration unit, a display unit, an operation unit, and a signal receiving unit. The display unit plays multimedia information. The server side is disposed with a database to store at least a piece of correlation information corresponding to the multimedia information. The IPTV interactive method mainly includes steps as follows.

In Step S510, a server side time calibration unit of a server side and a user side time calibration unit are connected through an Internet to calibrate a time of the digital signal control device.

In this embodiment, the server side time calibration unit is connected to a television station through the Internet to calibration the time of the server side, and the user side time calibration unit is accordingly connected to calibration the time of the user side, so the user side, the server side, and the television station are synchronous in time. The server side time calibration unit uses the information of SST in the PSIP data to calibrate the time calibration unit of the user side to calibrate the time of the user side to be synchronous with the server side.

In Step S520, an application server of the server side generates a widget menu page corresponding to the multimedia information through different parameters, and displays the widget menu page at the display unit of the user side.

In this embodiment, the widget menu page includes at least a widget, each widget is set with an identification code, and the application server recognizes an operation function set for the widget through the identification code. In addition, the widget menu page is arranged in classes and groups, so as to enable the user side to clearly find target content. The database further establishes an index catalog according to the television programs.

In Step S530, an operation unit inputs a control signal in the signal receiving unit.

In Step S540, according to the control signal, a network server of the server side is enabled to provide at least a widget corresponding to the control signal to be transferred to the user side and displayed at the display unit.

In this embodiment, the application server receives a web browsing HTTP request sent by the digital signal control device from the Internet, and returns an HTTP response to the digital signal control device, and at the same time the web page acquires the information required thereby from the database, and transfers web page content through the Internet to the digital signal control device for display at the display unit of the user side.

In addition, the application server further includes a real-time interactive function, and the real-time interactive function provides interactive games for a voting or questionaire survey function.

In Step S550, the correlation information corresponding to the control signal is stored in the database.

In addition, the digital signal control device further includes a bookmark function, the bookmark function records a list of widgets related to the watching program, for future representation, and the function application includes two operation modes of adding a bookmark and loading a bookmark.

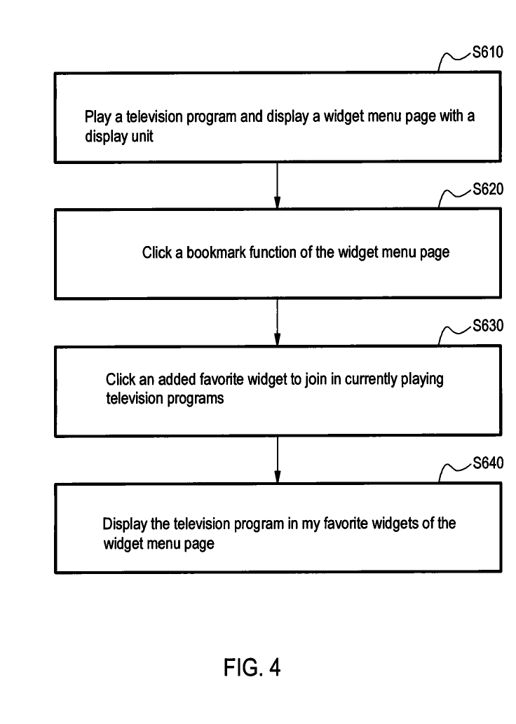

FIG. 4 is a flow chart of steps of establishing a bookmark function in an IPTV interactive method according to the present invention, which mainly includes steps as follows.

In Step S610, the display unit plays a television program and displays a widget menu page.

In Step S620, a bookmark function of the widget menu page is clicked.

In Step 5630, an added favorite widget is clicked to join in currently playing television programs.

In Step S640, the television program is displayed in my favorite widgets of the widget menu page.

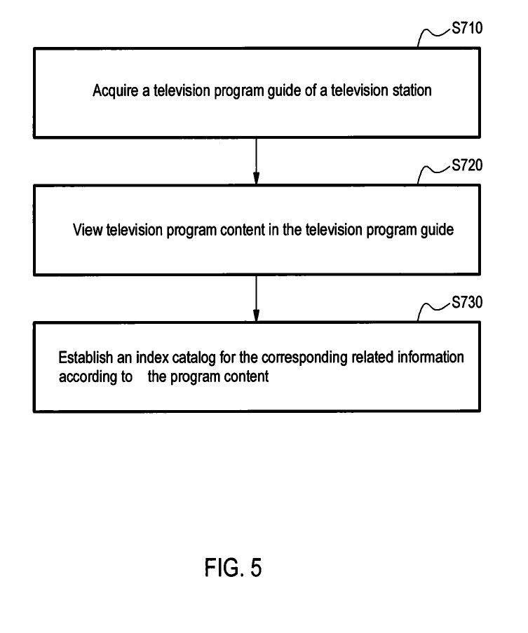

FIG. 5 is a flow chart of steps of establishing an index according to television programs by a database in an IPTV interactive method according to the present invention, which mainly includes steps as follows.

In Step S710, a television program guide of a television station is acquired.

In Step S720, a program content of a television program in the television program guide is viewed.

In Step S730, an index catalog is established for the corresponding related information according to the program content.

In conclusion, the present invention has the following characteristics:

(1) The user can easily access various content related to programs:

1. Food Program: a user can directly learn information of shops in the widget without having to query the television station.

2. Shopping Channel: a user can view detailed information of goods and directly order through the widget without making phone calls.

3. Program Voting Activity: a user can operate on the widget without using short messages or phone calls.

(2) When the user views content he liked, the user can bookmark the content for future reference and share the bookmark with friends.

Although the present invention is disclosed with the above embodiments, the present invention is not intended to be limited thereto. Equivalent replacements such as changes and medications made by persons skilled in the art without departing from the spirit and scope of the present invention shall still fall within the protection scope of the present invention.

What is claimed is:

1. An Internet Protocol television (IPTV) interactive system, comprising:
a user side, disposed with a digital signal control device, and comprising:
a user side time calibration unit, disposed at the digital signal control device;
a display unit, used for displaying multimedia information;
an operation unit, used for outputting a control signal; and
a signal receiving unit, disposed at the digital signal control device to receive the control signal;
a server side, comprising:
a server side time calibration unit, linked to the user side time calibration unit to adjust a time of the user side to be synchronous with the server side;
an application server, used for generating a widget menu page corresponding to the multimedia information through different parameters, and displaying the widget menu page at the display unit of the user side;
a network server, used for transferring information of a widget corresponding to the control signal to the user side and displaying the information at the display unit according to the control signal of the user side; and
a database, used for storing at least a piece of correlation information corresponding to the multimedia information, so as to provide the correlation information for access by the application server and the network server, and saving the correlation information according to the control signal,
wherein the user side operates the digital signal control device through the operation unit via the display unit, the digital signal control device is linked to the network server and the application server of the server side through an Internet, so as to access related data at the database, the digital signal control device transfers the correlation information provided by the network server back to the user side through the Internet to be viewed through the display unit, and the operation unit executes other function applications.

2. The IPTV interactive system according to claim 1, wherein the digital signal control device provides television program content as well as web browsing content, program content information, and program music play content related thereto to the user side.

3. The IPTV interactive system according to claim 1, wherein each the widget is set with an identification code, and the application server recognizes an operation function set for the widget through the identification code.

4. The IPTV interactive system according to claim 1, wherein the widget menu page is arranged in classes and groups, so as to enable the user side to clearly find target content.

5. The IPTV interactive system according to claim 1, wherein the database further establishes an index catalog according to television programs.

6. The IPTV interactive system according to claim 1, wherein the application server receives a web browsing HyperText Transfer Protocol (HTTP) request sent by the digital signal control device from the Internet, and returns an HTTP response to the digital signal control device, and at the same time a web page acquires information required thereby from the database and transfers web page content through the Internet to the digital signal control device for display at the display unit of the user side.

7. The IPTV interactive system according to claim 1, wherein the digital signal control device further comprises a bookmark function, the bookmark function records a list of widgets related to the watching program, for future representation, and the function application comprises two operation modes of adding a bookmark and loading a bookmark.

8. The IPTV interactive system according to claim 1, wherein the application server further comprises a real-time interactive function, and the real-time interactive function provides interactive games for a voting or questionaire survey function.

9. The IPTV interactive system according to claim 8, wherein the server side time calibration unit is connected to a television station through the Internet to calibrate a time of the server side, then the user side time calibration unit is connected accordingly to calibrate the time of the user side, so the user side, the server side, and a time of television station are synchronous, thus ensuring that the real-time interactive function provided by the server side and a program time of the television station practically corresponds to each other.

10. The IPTV interactive system according to claim 1, wherein the digital signal control device confirms a connection state every other preset time.

11. The IPTV interactive system according to claim 1, wherein the widget menu page comprises time-sensitive widgets and time-insensitive widgets.

12. The IPTV interactive system according to claim 11, wherein the time-sensitive widget is directly downloaded and executed after clicking, automatically deleted when a time limit is reached, and only deleted after being switched off by a user if the widget is still being executed when the time limit is reached.

13. The IPTV interactive system according to claim 11, wherein the time-insensitive widget has to be used after installation, and when being clicked in a list, it is queried whether to install the time-insensitive widget, and the time-insensitive widget is installed and executed after confirmation, and otherwise, the time-insensitive widget is neither installed nor executed.

14. An Internet Protocol television (IPTV) interactive device, comprising:
a user side, comprising:
a digital signal control device;
an operation unit, used for outputting a control signal;
a user side time calibration unit, disposed at the digital signal control device;
a display unit, electrically connected to the digital signal control device and used for displaying multimedia information; and
a signal receiving unit, disposed at the digital signal control device and used for receiving the control signal;
a server side, comprising:
a server side time calibration unit, linked to the user side time calibration unit to adjust a time of the user side to be synchronous with the server side;
an application server, used for generating a widget menu page corresponding to the multimedia information through different parameters, and displaying the widget menu page at the display unit of the user side;
a network server, used for transferring information of a widget corresponding to the control signal to the user side and displaying the information at the display unit according to the control signal of the user side; and
a database, used for storing at least a piece of correlation information corresponding to the multimedia information, so as to provide the correlation information for access by the application server and the network server, and saving the correlation information according to the control signal,
wherein the user side operates the digital signal control device through the operation unit via the display unit, the digital signal control device is linked to the network server and the application server of the server side through an Internet, so sa to access related data at the database, the digital signal control device transfers the correlation information provided by the network server back to the user side through the Internet to be viewed through the display unit, and the operation unit executes other function applications.

15. An Internet Protocol television (IPTV) interactive method, applicable to a user side disposed with a digital signal control device and a server side, wherein the user side comprises at least a user side time calibration unit, a display unit, an operation unit, and a signal receiving unit, the display unit plays multimedia information, the server side is disposed with a database for storing at least a piece of correlation information corresponding to the multimedia information, and the method comprises:
connecting server side time calibration unit of the server side and the user side time calibration unit through an Internet to calibration a time of the digital signal control device;
generating, by an application server of the server side, a widget menu page corresponding to the multimedia information through different parameters, and displaying the widget menu page at the display unit of the user side;
inputting, by the operation unit, a control signal in the signal receiving unit;
enabling a network server of the server side according to the control signal to provide information of at least a widget corresponding to the control signal to be transferred to the user side and displayed at the display unit; and
storing the correlation information corresponding to the control signal in the database.

16. The IPTV interactive method according to claim 15, wherein the digital signal control device provides television program content as well as web browsing content, program content information, and program music play content related thereto to the user side.

17. The IPTV interactive method according to claim 15, wherein each the widget is set with an identification code, and the application server recognizes an operation function set for the widget through the identification code.

18. The IPTV interactive method according to claim 15, wherein the widget menu page is arranged in classes and groups, so as to enable the user side to clearly find target content.

19. The IPTV interactive method according to claim 15, wherein the database further establishes an index catalog according to television program, and the step of establishing comprises:
acquiring a television program guide of a television station;
viewing program content of a television program in the television program guide; and
establishing an index catalog for corresponding related information according to the program content.

20. The IPTV interactive method according to claim 15, wherein the application server receives a web browsing HyperText Transfer Protocol (HTTP) request sent by the digital signal control device from the Internet, and returns an HTTP response to the digital signal control device, and at the same time a web page acquires information required thereby from the database, and transfers web page content through the Internet to the digital signal control device for display at the display unit of the user side.

21. The IPTV interactive method according to claim 15, wherein the digital signal control device further comprises a bookmark function, the bookmark function records a list of widgets related to the watching program, for future representation, and the function application comprises two operation modes of adding a bookmark and loading a bookmark.

22. The IPTV interactive method according to claim 15, wherein the application server further comprises a real-time interactive function, and the real-time interactive function provides interactive games for a voting or questionaire survey function.

23. The IPTV interactive method according to claim 22, wherein the server side time calibration unit is connected to a television station through the Internet to calibrate a time of the server side, and then the user side time calibration unit is accordingly connected to calibrate the time of the user side, so the user side, the server side, and a time of the television station are synchronous, thus ensuring the real-time interactive function provided by the server side and the program time of the television station correspond to each other.

24. The IPTV interactive method according to claim 15, wherein the digital signal control device confirms a connection state every other preset time.

25. The IPTV interactive method according to claim 15, wherein the widget menu page comprises time-sensitive widgets and time-insensitive widgets.

26. The IPTV interactive method according to claim 25, wherein the time-sensitive widget is directly downloaded and executed after being clicked, automatically deleted after a time limit is reached, and only deleted after being switched off by a user if the widget is still being executed.

27. The IPTV interactive method according to claim 25, wherein the time-insensitive widget has to be used after installation, and when being clicked in a list, it is queried whether to install the time-insensitive widget, the time-insensitive widget is installed and executed after confirmation, and otherwise, the time-insensitive widget is neither installed nor executed.
